(19) United States
(12) Patent Application Publication
(10) Pub. No.: US 2009/0053458 A1
(43) Pub. Date: Feb. 26, 2009

(54) Composite Material

(76) Inventor: Michael Ian Birrell, Hartfordshire (GB)

Correspondence Address: BOYLE FREDRICKSON S.C., 840 North Plankinton Avenue, MILWAUKEE, WI, 53203, US

(21) Appl. No.: 12/093,058

(22) PCT Filed: Nov. 6, 2006
(86) PCT No.: PCT/GB06/04118

§ 371 Date: May 8, 2008

(30) Foreign Application Priority Data
Nov. 10, 2005 (GB) 0522960.4

(51) Int. Cl. B32B 3/02; B31B 1/60

(52) U.S. Cl. 428/68; 156/60

(57) ABSTRACT

A formed thermoplastics composite sheet (100) having a laminated structure wherein the laminate comprises at least a first (112) and a second (114) cover layer, each being fibre reinforced, in between which, in at least a portion of the sheet, there is provided a core layer (106) comprising a deformable metallic element such that the deformable element is arranged to reduce the elastic behaviour of the thermoplastic composite (100) when compared to the sheet without the deformable element.

### FIELD OF THE INVENTION

The present invention relates to a composite material, particularly, but not exclusively, to a composite material arranged to be used in a vehicle body panel.

### BACKGROUND OF THE INVENTION

It is convenient to set the background of the present invention with reference to the field of vehicle body panels although it has wider applicability. It is know to fabricate car body panels (such as the bonnet/hood) from a plastics material. Generally, such a plastics body panel is made from a thermoset composite but it is possible to manufacture such a panel from a thermoplastic composite. In the case of thermoplastic composites the panels tend to behave elastically during impacts (unless the elastic limit is exceeded) such that they return to their original shape. This can be disadvantageous during certain collisions such as when the vehicle collides with a pedestrian or animal, etc. In such instances the elastic behaviour can tend to launch the pedestrian, etc. away from the vehicle thereby increasing his/her injuries.

GB 305 694 shows a panel in which a polymer material is used to protect a metal structural member positioned within the polymer.

### SUMMARY OF THE INVENTION

According to a first aspect of the invention there is provided a thermoplastics composite material having a laminated structure wherein the laminate comprises at least a first and a second cover layer in between which, in at least a portion of the material, there is provided a core layer comprising a deformable element.

It is believed that a thermoset material would not be suitable for embodiments of the invention since they are likely to be too brittle, and therefore not ductile enough, such that they will tend to fail upon an impact.

According to a second aspect of the invention there is provided a panel comprising a laminated plastics material structure having at least a first cover layer and a second cover layer, in between which, in at least a portion of the panel, there is provided a core layer comprising a deformable element arranged to undergo permanent deformation during deformation of the panel.

Generally the panel is a vehicle body panel. However, this need not be the case and the panel may be any panel which may suffer from an impact.

According to a third aspect of the invention there is provided a method of manufacturing a panel comprising
i. arranging at least a core layer comprising a deformable element and a cover layer on either side thereof;
ii. applying heat and pressure to consolidate the layers.

Generally, the method will be used to manufacture vehicle body panels. However, this need not be the case and the method may be applied to any panel. which may suffer from an impact.

According to a fourth aspect of the invention there is provided a method of manufacturing a composite material comprising:
i. arranging at least a core layer comprising a deformable element and a cover layer on either side thereof;
ii. applying heat and pressure to consolidate the layers.

The core layer may comprise a thermoplastics material matrix in which a deformable element is arranged. Such a matrix is convenient because it may improve the adhesion between the cover layers to adhere and the deformable elements.

The core layer may comprise a material provided by Bekaert under the Trade Mark Santoprene.

According to a fifth aspect of the invention there is provided a car body panel, such as a bonnet, comprising a laminated plastics material structure having at least a first cover layer and a second cover layer, in between which, in a central region of the panel there is provided a core layer comprising a plurality of metallic wires arranged such that the panel undergoes permanent deformation in the central region during an impact thereto.

According to a sixth aspect of the invention there is provided a method of reducing pedestrian injuries comprising providing a vehicle with a body panel according to the fifth aspect of the invention.

### BRIEF DESCRIPTION OF THE DRAWINGS

There now follows by way of example only a detailed description of embodiments of the present invention with reference to the accompanying drawings of which:

FIG. 1 schematically shows an exploded view of the layers within a formed composite sheet according to an embodiment of the invention;

FIG. 2 schematically shows an enlargement of one of the layers shown in FIG. 1;

FIG. 3 schematically shows a vehicle body panel in which a portion comprises a composite material according to an embodiment of the invention;

FIG. 4 schematically shows a section through the body panel along line A of FIG. 3; and

FIG. 5 schematically shows various forms in which a deformable element may be provided.

### DETAILED DESCRIPTION OF THE DRAWINGS

The formed composite sheet 100 shown in exploded form comprises, in this embodiment, five layers 102 to 110. In other embodiments there may be other numbers of layers.

In this embodiment the topmost two layers 102,104 together provide what may be termed a first cover layer 112; i.e. the cover layer comprises two sub-layers. The bottommost two layers 108,110 together provide what may be termed a second cover layer 114; and again comprises two sub layers. There may be other numbers of sub-layers within the cover layers. In between the first 112 and the second 114 cover layer there is provided a core layer 106 which comprises a deformable element.

In it's widest sense the deformable element that is incorporated in the composite sheet such that it substantially stops, or at least reduces, the composite sheet from exhibiting elastic behaviour. For example embodiments may be arranged such that the sheet undergoes permanent deformation during an impact. There may be some recovery from the deformation (i.e. partial elastic behaviour) but the deformable element may largely reduce the recovery thereby helping to prevent energy being returned to the object that impacted the sheet. It is known that thermoplastic polymers have a ‘memory’ and exhibit an ability to recover their form after an impact. The introduction of a core layer comprising a deformable element (which may be thought of as stiffer than the cover layers) that does not have such a recovery property helps to prevent, or substantially reduce, the overall recovery of the panel.

Generally, the deformable element will comprise a metallic matrix. The metallic matrix may usually be steel or a steel alloy, but could equally be other metals/alloys, such as aluminium or the like.

In the embodiment of FIG. 1 the layer 106 comprising the deformable element is shown as comprising a plurality of metallic wires without a surrounding matrix. This is one possibility although the deformable element may be provided in a number of forms as described elsewhere. Moreover, the deformable elements may generally be provided within a thermoplastics material matrix in order to facilitate the fabrication of the composite material. In embodiments in which the deformable element is provided in a thermoplastics material matrix it may be found that the plastics material adheres better to the deformable element.

In some embodiments there may be provided a plurality of core layers, which may or may not have other layers in between. Such additional core layers may be used to tailor the properties of the material/panel in which the material is used.

As shown in FIG. 1 each of the cover layers 112,114 may comprise a plurality of sub-layers. In this embodiment each of the cover layers is shown as comprising what is termed a 0/90 lay up of fibre reinforcement; i.e. a first sub-layer having fibres oriented at 0° and a second sub-layer having fibres oriented at 90° relative to the first sub-layer. Thus, the properties of the cover layers 112,114 can be tailored as desired by appropriate use of reinforcement.

Thus, the structure may be thought of as a composite lay-up which has first and second cover layers together with a core layer which itself comprises a deformable element. In such an embodiment, the properties of a consolidated panel are different when compared to the properties of each layer.

An advantage of using fibre reinforcement in the cover layers is that increased thermal stability may be achieved. Such stability may be advantageous in applications such as vehicle panels where it is helpful if the panel does not undergo significant expansion over its operational temperature range (the extremes of which could run from −40° C. to a solar loading of 130° C.). Further, panels may be exposed to ovens during a painting process which can expose the panel to temperatures of on the order of 200° C. In view of the large temperature ranges, it is therefore advantageous that embodiments of the invention match the thermal expansion of the cover layers to that of the metallic element. Such matching may be achieved by appropriate arrangement of reinforcing fibres in the cover layers.

Thermal stability may be further increased if uni-directional fibres are used as a reinforcing element in the cover layers. As such a sub-layer of the cover layer may comprise reinforcing fibres running in substantially a single direction such that the overall cover layer comprises fibres running in different directions.

The sub-layers within each of the cover layers 112,114 (or indeed the core layer) may comprise any of the following: a pre-preg lay up of oriented fibre reinforcement; random fibre reinforced thermoplastic; self reinforced polymer sheet; a quasi isotropic lay-up of fibres; or a woven thermoplastic composite matrix or the like. Provision of the cover layers, as shown in this embodiment, is advantageous because it allows a generally smooth top surface to be provided which masks any imperfections in surface aspect caused by the deformable element in the core layer 106. Such imperfections would generally be referred to as witness marks. Such a generally smooth surface is beneficial in embodiments which are intended for use as a vehicle body panel in order that a good paint finish can be achieved on the panel (or indeed in other application in which a high class finish of the panel is desired). The use of substantially unidirectional fibres within a sub-layer of a cover layer may increase the resistance to witness marks in the surface of the panel.

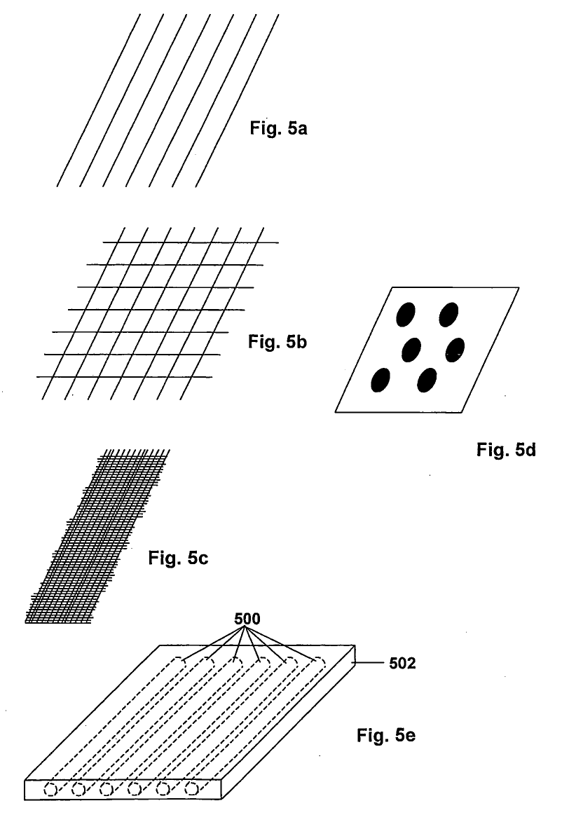

In this embodiment the metallic deformable element may comprise any one of the following: wire, cord, braid, perforated sheet or mesh; wire, cord, braid, perforated sheet or mesh which has been encapsulated in a thermoplastics material compatible with the plastics material in the cover layers. FIG. 5 shows examples of such embodiments: FIG. 5a shows a plurality of wires; FIG. 5b shows a mesh, FIG. 5c shows a braid and FIG. 5d shows a perforated sheet. Each of these, or other, deformable members may be provided within a matrix.

FIG. 5e shows a plurality of wires 500 within a thermoplastics material matrix 502. Any other form of deformable element may also be provided in a similar matrix 502. Some embodiments of the invention may comprise additional layers than those shown in FIG. 1. There may for example be a plurality of core layers comprising deformable layers. There may be additional sub layers within each of the cover layers.

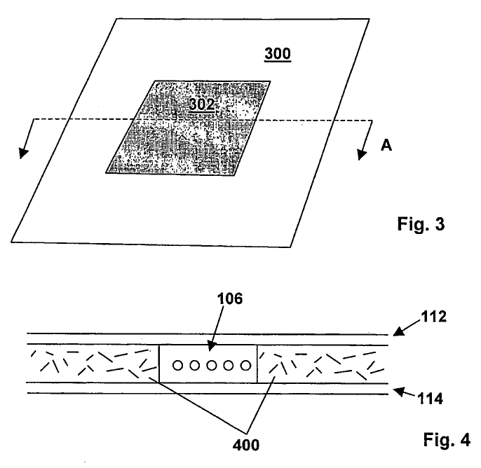

In some embodiments, for example as shown in FIG. 3, the core layer comprising the deformable element may be provided in a portion of the overall area. In such arrangement the deformable element may be considered to be positioned in a localised area. FIG. 3 shows a vehicle body panel 300 (for example a vehicle bonnet/hood, a door, a wing, a roof panel, or the like) in which a core layer comprising a deformable element is provided at a central region 302 thereof. In alternative embodiments the deformable element may be provided in a different region, such the front, rear etc. In some embodiments the formed composite sheet may comprise more that one deformable element, such as 2, 3, 4, 10 or any number there between. Furthermore the composite sheet may comprise deformable elements of alternative topologies, such a circular shaped or the like. A person skilled in the art will readily appreciate that different applications may require different configurations and be able to adapt the composite sheet accordingly.

In such embodiments, areas of the composite material/vehicle body panel may comprise one or more infill-core 400 layers in addition to the two cover layers 112,114 in areas in which the deformable element is not provided. Such infill-core layers 400 are advantageous in order to help ensure that the thickness of the overall panel/composite material remains substantially constant, if it is desired to have a constant thickness. Such infill-core layers 400 will generally comprise a thermoplastics material which is compatible with the thermoplastics material in the cover layers 112,114, or indeed are substantially the same thermoplastics material. The infill-core layers 400 may or may not be reinforced, although FIG. 4 shows these layers to be reinforced with a randomly oriented short fibre. Compatible is intended to mean that the thermoplastics can mix with one another without affecting the properties of either of the thermoplastics or of the combination. In one case the compatible thermoplastics may comprise the same, or substantially the same, polymeric material.

In some embodiments, an infill-core layer may be used, of an appropriate thickness, in order to tailor the thickness of the panel as desired. For example, if a thicker portion of the panel is desired then a thicker infill-core layer may be used and if a thinner panel is desired then a thinner infill-core layer may be used.

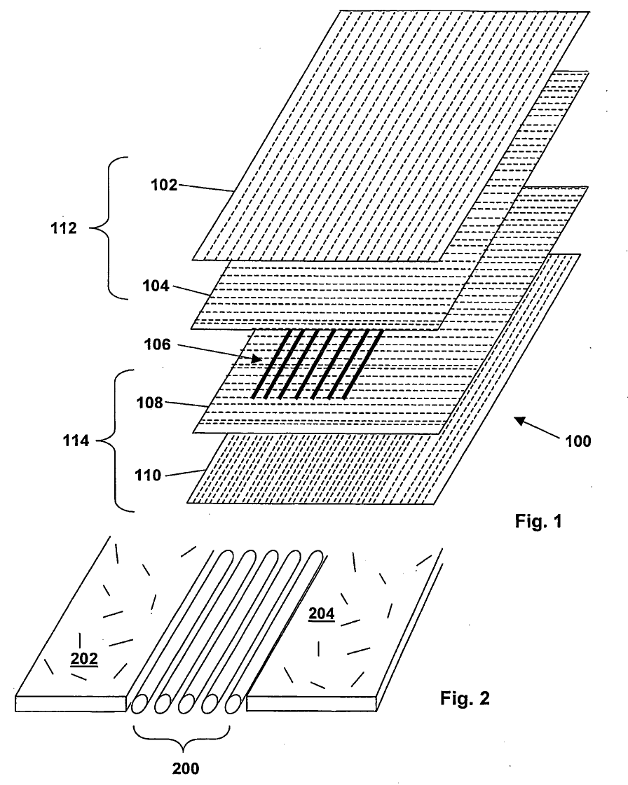

An embodiment in which the deformable element covers less than the area of the panel is shown in FIG. 2. The core layer 200 containing the deformable element is shown in a central region and an infill-core layers 202, 204 is shown on each side thereof. In the embodiment shown, the infill-core layers are reinforced with random fibres within the plastics material matrix. Other embodiments may not be reinforced or may be reinforced with other known techniques.

A vehicle body panel 300 as for example described in relation to FIGS. 3 and 4 may be advantageous since it allows a panel to be provided which is substantially smooth and therefore may allow a high class paint finish to be achieved. Furthermore, the deformable elements allow the deformation characteristics of the panel to be tailored. In some panels, it is advantageous if the panel does not show elastic behaviour once it is deformed. For example, in a vehicle bonnet/hood it has been found that injury to pedestrians which have been hit by the vehicle can be increased if the bonnet/hood springs back to its original shape (i.e. exhibits elastic behaviour) because the pedestrian may be propelled by the panel returning to its original shape increasing his/her injuries. By appropriate selection of the deformable elements a composite thermoplastics material panel may be provided which exhibits permanent deformation and thereby should not propel a pedestrian in this manner.

The thermoplastics material/vehicle body panel may be fabricated as is known in the art by combining (often referred to as laying up) a plurality of layers (e.g. in the example of FIG. 1 the layers 102-110) and then heating the layers to their melt temperature and consolidating the structure under pressure. Processes such as vacuum consolidation, pressing or the like may be used to consolidate the composite into the required form. The laying up may be performed automatically by machine in a high volume process, or manually in a lower volume process. Thus, a homologous structure results once the consolidation is performed.

It will be readily appreciated that by consolidating the panel this has the effect of substantially removing any gas pockets within the composite. The result is a composite that is constructed as a substantially solid material.

If the deformable insert is metallic, or another material with a high thermal conductivity, it may be possible to use the deformable element to conduct heat into the material for this consolidation process.

Generally, a panel formed by the process outlined in this embodiment does not have any areas of high curvature (e.g. a vehicle bonnet/hood) and therefore the deformable insert need not be deformed before the consolidation process; i.e. it may, in such embodiment, be used in sheet form. In other embodiments, if there were a higher degree of curvature it may be necessary to shape the deformable element before the layers are laid up before the consolidation process.

The thermoplastics material may be any suitable thermoplastics material such as polypropylene, PET, PBT, polycarbonate, nylon thermoplastic polyurethane or thermoplastic material blends.

In the example of polypropylene as the thermoplastics material in the cover and core layers the structure would be heated to between roughly 180° C. and 220° C. with a consolidation pressure of roughly 1 bar or greater. Other thermoplastics materials may require other temperatures and pressures as will be appreciated by the person skilled in the art.

In one embodiment, the deformable core layer 106 is provided as a layer provided by Bekaert under the name Santoprene™, which in one embodiment comprises wire of diameter or roughly 1 mm surrounded by a thermoplastics matrix. This is of a similar structure to that shown in FIG. 5d. It will be readily appreciated however that alternative materials may be used. Indeed the wire diameter do not need to be 1 mm and may be 0.1 mm, 0.5 mm, 2 mm, 5 mm or any number there between. In such alternative arrangements, the properties of the material of the deformable element, such as the metal used, may dictate which geometry is best suited for the application.

Although primarily described in relation to a vehicle body panel, embodiments of the invention may also provide any panel which may be subject to an impact. For example, a road sign, a panel for a door, or the like.

A typical thickness of a panel according to an embodiment of the invention is likely to be roughly in the range of between 1 mm and 10 mm in thickness. More generally, the panel may be roughly 5 mm or less.

1-33. (canceled)

34. A formed thermoplastics composite sheet having a laminated structure wherein the laminate comprises at least a first and a second cover layer, each being fibre reinforced, in between which, in at least a portion of the sheet, there is provided a core layer comprising a deformable metallic element such that the deformable element is arranged to reduce the elastic behaviour of the thermoplastic composite when compared to the sheet without the deformable element.

35. A sheet according to claim 34 wherein each cover comprises a plurality of sub-layers wherein the fibre reinforcement within each sub-layer is substantially unidirectional.

36. A sheet according to claim 35 wherein each cover layer comprises at least a first and a second sub-layers wherein the fibre reinforcement within the first layer is arranged to be substantially at 90 degrees to the fibre reinforcement in the second sub-layer.

37. A sheet according to claim 34, wherein there is provided at least one infill core layer, arranged in areas of the core layer where there is no deformable metallic element.

38. A panel comprising a laminated plastics material structure having at least a first cover layer and a second cover layer, each of which is fibre reinforced, and in between which, in a least a portion of the panel, there is provided a core layer comprising at least one deformable metallic element wherein the introduction of the deformable element is arranged to reduce the elastic behaviour of the plastics material structure, when compared to the panel without the element, such that the panel undergoes permanent deformation during an impact.

39. A panel according to claim 38 in which the metallic element is provided in any of the following forms: a braid, a wire, a perforated plate, a mesh, a sheet.

40. A panel according to claim 38, wherein there is provided at least one infill core layer, arranged in areas of the core layer where there is no deformable element.

41. A panel according to claims 38 in which the cover layers each comprises at least one fibre reinforced sub-layer having fibres running in substantially a single direction.

42. A panel according to claim 38 in which each cover layer comprises at least a first and a second sub-layers wherein the fibre reinforcement within the first layer is arranged to be substantially at 90 degrees to the fibre reinforcement in the second sublayer.

43. A panel according to claim 38 in which each of the cover layers each comprises the same, or at least a compatible, matrix material compared to the core layer.

44. A panel according to claim 38 which is a vehicle body panel, including a bonnet (i.e. a hood), a door, a roof panel.

45. A method of manufacturing a panel comprising:
i. arranging at least a core layer comprising a deformable element and a fibre-reinforced cover layer on either side thereof;
ii. applying heat and pressure to consolidate the layers.

46. A method according to claim 45 in which the core layer extends for less than the entire area of the panel.

47. A method according to claim 46 in which an infill-core layer is provided in areas in which the core layer does not extend.

48. A method according to claim 47 in which the infill-core layer is used to tailor the thickness of the panel to provide thickening or thinning of the panel.

49. A method according to claim 45 in which the core layer is provided as a matrix of plastics material containing the deformable element.

50. A method according to claim 49 in which the matrix of plastics material containing the deformable element is further defined as a thermoplastic elastomer that is a mixture of in-situ cross linking of EDPM rubber and polypropylene.

51. A method according to claim 45 which is used to produce a vehicle body panel.

52. A method according to claim 45 wherein the deformable element maintains a shape nearer a deflected shape than an original shape after an impact.

53. A car body panel, such as a bonnet, comprising a consolidated structure having at least a first cover layer and a second cover layer, each being fibre reinforced, in between which, in a central region of the panel there is provided a core layer comprising a plurality of metallic wires arranged to deflect during an impact to the panel such that the panel undergoes permanent deformation during the impact.
